(19) United States
(12) Patent Application Publication
(10) Pub. No.: US 2008/0290825 A1
(43) Pub. Date: Nov. 27, 2008

(54) POWER ARCHITECTURE AND BRAKING CIRCUITS FOR DC MOTOR-PROPELLED VEHICLE

(75) Inventors: Alain St-Jacques, St-Bruno (CA); Andrew C. Tarnow, Cambridge Springs, PA (US); Frank Wegner Donnelly, North Vancouver (CA)

Correspondence Address: MERCHANT & GOULD PC, P.O. BOX 2903, MINNEAPOLIS, MN, 55402-0903, US

(73) Assignee: RAIL POWER TECHNOLOGIES CORP, Brossard (CA)

(21) Appl. No.: 12/127,317

(22) Filed: May 27, 2008

Related U.S. Application Data
(60) Provisional application No. 60/940,370, filed on May 25, 2007.

(51) Int. Cl. H02P 3/12

(52) U.S. Cl. 318/380

(57) ABSTRACT

A dynamic braking circuit that can be operated with stability over both high and low speed regimes. This circuit has the advantage of using fewer components than previous circuits. In addition, when in braking mode, the armature and field currents tend to oppose each other across the main braking switch hence reducing electromechanical stresses when in high current regime. According to a second embodiment, a dynamic braking circuit implements a “soft” extended braking function with the capability of providing a smoother braking action at high braking effort at little extra cost resulting from the replacement of a contactor by a reverser. The main advantages of this preferred embodiment are that the current generated by the armatures during braking can be controlled independently from the excitation of the field windings at low speeds and that it enables simultaneous self supply, regeneration and dynamic braking.

The present application claims priority of U.S. Provisional patent application No. 60/940,370 filed May 25, 2007, the contents of which are incorporated herein by reference.

### FIELD OF THE INVENTION

The present invention relates generally to a method for configuring traction and dynamic braking circuits for a combination of several Series DC motors supplied by a DC bus, as can be found on locomotives, which are operable at low speeds and are adaptable to regenerative braking.

### BACKGROUND OF THE INVENTION

Electrically propelled vehicles benefit from the advantage of being able to operate their traction motors in generator mode in order to produce braking energy that can be either dissipated in heat through a resistive load or recuperated in an electrical storage medium such as batteries. In both cases, there is a clear benefit in reduced maintenance of the otherwise standard mechanical friction brakes.

The use of high power series DC traction motors driven by electronic converters supplied from a DC bus has been in used on recent refurbished locomotives with or without electrochemical storage. In order to fully take advantage of the electrical propulsion in brake mode and, ideally, recover part of this energy in storage for further use, an electrical configuration circuit is desired that should use a minimum of components for cost and reliability while providing maximum functionality.

Two of the present inventors have disclosed a system for controlling a dynamic and regenerative braking system for a hybrid locomotive which employs a control strategy for orchestrating the flow of power amongst the prime mover, the energy storage system and the regenerative braking system in a U.S. patent application Ser. No. 11/200,879 filed Aug. 9, 2005 entitled “Regenerative Braking Methods for a Hybrid Locomotive” which is also incorporated herein by reference.

As presented in U.S. patent application Ser. No. 11/200,879 entitled “Regenerative Braking Methods for a Hybrid Locomotive”, the concept was to recover energy from the traction motors to either dissipate this power in resistive grids (dynamic braking) and/or feed this power into a DC bus if the DC bus is equipped with any means of energy storage, such as for example, a battery pack, a capacitor bank and/or a flywheel system. As shown in FIG. 23 of U.S. patent application Ser. No. 11/200,879, the proposed method consists in reversing the power flow of the armature and field windings in series to switch from the motoring to braking mode. In this configuration with both windings in series, it may be difficult to control the power drawn from the traction motors in braking mode.

In U.S. patent application Ser. No. 11/200,881 filed Aug. 9, 2005 entitled “Locomotive Power Train Architecture”, Donnelly et al. have further disclosed a general electrical architecture for locomotives based on plurality of power sources, fuel and drive train combinations. The power sources may be any combination of engines, energy storage and regenerative braking. This application is also incorporated herein by reference.

In rail yard switching operations, for example, a locomotive may be operated primarily at low speed (speeds less than about 15 mph) with multiple stop and starts. In these situations, the braking system is worked hard and is a high maintenance system on the locomotive. Further, if the brake system locks up, it can cause wheel skid which can result in flat spots developing on the skidding wheels. Flat spots are a further costly high maintenance operation usually requiring wheel replacement.

In a US patent application entitled “Dynamic Braking Circuit for a Hybrid Locomotive” filed Apr. 19, 2007 to Donnelly, Bailey, Redinger, Tarnow, a circuit is disclosed that utilizes the locomotive's traction motors to return energy from braking to a least one of the locomotive's diesel engines, energy storage system or dynamic braking system in a way that minimizes wheel skid and in a way that provides seamless braking action down to and including 0 mph. This application is also incorporated herein by reference.

There remains a need for an electrical braking system that can be used in conjunction with or instead of a mechanical or pneumatic braking system with a minimum of components, which is robust and particularly suited for operations over a wide range of speeds, especially at low speeds wherein the braking effort remains high.

### SUMMARY OF THE INVENTION

These and other advantages will be apparent from the disclosure of the invention(s) contained herein.

The inventions and their various embodiments and configurations disclosed herein are directed generally to a dynamic braking method for an electrical DC motors propelled vehicle which minimizes the tendency for wheel skid and can be used preferentially to pneumatic or mechanical braking systems. The inventions disclosed herein may be used on a conventional diesel-electric vehicle; a multi-engine diesel-electric vehicle; or a hybrid vehicle comprised of one or more engines and an energy storage system. The energy produced during braking can be utilized or discarded. If utilized, it can be stored in an energy storage system such as for example a battery pack or a capacitor bank or it can be used to power the electrical braking control and auxiliary power systems on the vehicle. If discarded, it can be routed to a dissipative resistive grid or can be dissipated by routing it through generator such as, for example, an induction alternator, a synchronous alternator or the like, to do work against the prime engine (engine braking).

All inventions presented relate to methods of controlling a pair of series DC motors. Any number of such DC motors may be grouped in pairs so that the same approach may be used effectively on any even multiple of motors supplied by one or more DC busses.

In a first invention, a dynamic braking circuit is disclosed that can be operated with stability over both high and low speed regimes. This circuit has the advantage of using fewer components than previous circuits. In addition, when in braking mode, the armature and field currents tend to oppose each other across the main braking switch hence reducing electromechanical stresses when in high current regime.

According to the present invention, there is provided a method of braking a vehicle, the vehicle comprising a pair of traction motor circuits for moving the vehicle and generating electrical energy when the vehicle is decelerating, wherein each traction motor circuit comprises a field winding and an armature winding, the field and armature windings being connected in series, each armature winding having an input terminal and an output terminal, wherein each traction motor circuit comprises a switchable contact reverser operable to switch electrical current in opposite directions of flow through the armature and field windings of a selected one of the pair of traction motor circuits, a power source to provide electrical energy to each said traction motor circuit, a direct current (DC) bus interconnecting each said traction motor circuit and said power source, and first and second pairs of first and second transistors, each of the first and second transistors comprising an input and an output, wherein the first pair of first and second transistors is connected in parallel with the second pair of first and second transistors to the DC bus, wherein in each of the first and second pairs of transistors, the output of the first transistor is connected to the input of the second transistor, wherein a first of the pair of traction motor circuits is connected, through a first contactor, in parallel with the first transistor of the first transistor pair, a second of the pair of traction motor circuits is connected, through a second contactor, in parallel with the second transistor of the second transistor pair, wherein the input terminal of the armature winding of the first of the pair of traction motor circuits is connected through a third contactor to the output terminal of the armature winding of the second of the pair of traction motor circuits, wherein the output terminal of the armature winding of the first of the pair of traction motor circuits is connected to the input terminal of the armature winding of the second of the pair of traction motor circuits through a first connection comprising a power switch and a first braking resistor connected in series, wherein the first connection is connected between a second connection connecting the output terminal of the armature winding of the first of the pair of traction motor circuits to the first contactor and a third connection connecting the input terminal of the armature winding of the second of the pair of traction motor circuits to the second contactor, and wherein, in a motoring mode, the first and second contactors are closed, and the power switch and third contactor are open, the method comprising the steps of:
a) releasing motor current until reduced to substantially zero;
b) opening the first and second contactors; and
c) closing the power switch and the third contactor.

According to the present invention, there is also provided a traction motor control circuit adapted for motoring and braking a vehicle, the vehicle comprising the components as described in the previous paragraph.

According to a second invention, a dynamic braking circuit is disclosed to implement a “soft” extended braking function with the capability of providing a smoother braking action at high braking effort at little extra cost resulting from the replacement of a contactor by a reverser. The main advantages of this preferred embodiment are that the current generated by the armatures during braking can be controlled independently from the excitation of the field windings at low speeds and that it enables simultaneous self supply, regeneration and dynamic braking. The motoring mode is operated in a manner similar to previous approaches where field and armature of each motor are connected in series and independently controlled by an electronic high-speed switch. However, in braking mode, one of the two high speed switches is reconfigured to control the field current of both motors. The armature windings are now connected in series as a high voltage source to feed the resistor grid, provide power to the field control circuit (self-supply) and/or regenerate power to a DC bus connected energy reserve. At low speeds, the second switch is commutated to maintain the armature current and, hence, the braking torque, often called effort. Another advantage of this second invention lies in its capability of using the dynamic braking grid to load test the energy generation sources of the system connected to the DC bus. This capability is known in locomotive applications as “self-load” and frequently used to test diesel-electric sources before going on the road.

According to the present invention, there is also provided a method of braking a vehicle, the vehicle comprising a pair of traction motor circuits for moving the vehicle and generating electrical energy when the vehicle is decelerating, wherein each traction motor circuit comprises a field winding and an armature winding, the field and armature windings being connected in series, each armature winding having an input terminal and an output terminal, wherein each traction motor circuit comprises a switchable contact reverser operable to switch electrical current in opposite directions of flow through the armature and field windings of a selected one of the pair of traction motor circuits, and wherein a third switchable contact reverser is provided to selectively connect in series each field winding to its corresponding armature winding within each traction motor circuit or connect in series the field winding of the first traction motor circuit to the field winding of the second traction motor circuit and the armature winding of the first traction motor circuit to the armature winding of the second traction motor circuit, a power source to provide electrical energy to each traction motor circuit, a direct current (DC) bus interconnecting each traction motor circuit and the power source, and first and second pairs of first and second transistors, each of the first and second transistors comprising an input and an output, wherein the first pair of first and second transistors is connected in parallel with the second pair of first and second transistors to the DC bus, wherein in each of the first and second pairs of transistors, the output of the first transistor is connected to the input of the second transistor, wherein a first of the pair of traction motor circuits is connected in parallel with the first transistor of the first transistor pair, a second of the pair of traction motor circuits is connected in parallel with the second transistor of the second transistor pair, wherein a braking resistor grid is connected in parallel with the first transistor of the second transistor pair, the braking resistor grid comprising a switch and a resistor connected in series, and wherein, in a motoring mode, the third switchable contact reverser is configured to connect in series each field winding to its corresponding armature winding within each said traction motor circuit and the braking resistor grid switch is open, the method comprising the steps of:
a) releasing motor current until reduced to substantially zero;
b) switching the third switchable contact reverser to connect in series the field winding of the first traction motor circuit to the field winding of the second traction motor circuit and the armature winding of the first traction motor circuit to the armature winding of the second traction motor circuit; and
c) closing the braking resistor grid switch.

According to the present invention, there is also provided a traction motor control circuit adapted for motoring and braking a vehicle, the vehicle comprising the components as described in the previous paragraph.

This embodiment is a preferred embodiment for both dynamic and regenerative braking on either multi engine locomotives, hybrid locomotives (including those with one or multiple prime movers). This embodiment is also applicable to any vehicles propelled by series-wound DC motors and equipped with a main DC bus. Examples of such vehicles include, for example, trucks, gantry cranes and marine craft.

Variants of this second embodiment are presented as alternatives enabling common braking resistance sharing amongst several pairs of traction motor circuits. In another variant of the second invention, a dynamic braking circuit is disclosed that can control motor torque, even at zero speed, thus enabling fast traction reversal.

By utilizing the dynamic braking circuit configurations described above, the possibility of wheel skid such as can occur when mechanical brakes lock up can be effectively eliminated. This, in turn, prevents flat spots from developing on locomotive wheels. Thus, the various embodiments of the present invention have the advantage of substantially reducing locomotive downtime and maintenance which are significant problems, for example, in yard switching operations. For example, multiple locomotives have been used in yard switching operations involving long trains to minimize wheel skid occurrences and pneumatic brake maintenance when the only the locomotives' independent braking systems are used. This is a wasteful practice since the multiple locomotives can generate far more power, produce more emissions and consume far more fuel than required. When the dynamic braking methods of the present invention are used, the mechanical brakes of the vehicle need only be used in heavy braking or emergency braking situations. This practice will substantially eliminate occurrences of wheel skid most typically associated with pneumatic brake systems. Thus locomotive brake maintenance problems can be minimized while using only one locomotive with concomitant savings in fuel costs and reduction of emissions.

As can be appreciated, the methods of dynamic braking disclosed herein can be blended with a locomotive's independent brake system for example in switch yard work where speeds often are low and there are frequent starts and stops. The method of dynamic braking can also be blended with a train's automatic brake system for example in road switchers and/or passenger trains where speeds are often high.

The above-described inventions and their embodiments and configurations are neither complete nor exhaustive. As will be appreciated, other embodiments of the invention are possible utilizing, alone or in combination, one or more of the features set forth above or described in detail below.

The following definitions are used herein:

A locomotive is generally a self-propelled railroad prime mover which is powered either by a steam engine, diesel engine or externally such as from an overhead electrical catenary or an electrical third rail.

A traction motor is a motor used primarily for propulsion such as commonly used in a locomotive. Examples are an AC induction motor, a DC (series, parallel or compound wounded) motor, a permanent magnet motor and a switched reluctance motor.

An engine refers to any device that uses energy to develop mechanical power, such as motion in some other machine. Examples are diesel engines, gas turbine engines, microturbines, Stirling engines and spark ignition engines.

A prime power source refers to any device that uses energy to develop mechanical or electrical power, such as motion in some other machine. Examples are diesel engines, gas turbine engines, microturbines, Stirling engines, spark ignition engines or fuel cells.

An energy storage system refers to any apparatus that accepts, stores and distributes mechanical or electrical energy which is produced from another energy source such as a prime energy source, a regenerative braking system, a third rail and a catenary and any external source of electrical energy. Examples are a battery pack, a bank of capacitors, a compressed air storage system and/or a bank of flywheels.

Dynamic braking is implemented when the electric propulsion motors are switched to generator mode during braking to augment the braking force. The electrical energy generated is typically dissipated in a resistance grid system.

Regenerative braking is the same as dynamic braking except the electrical energy generated is recaptured and stored in an energy storage system for future use.

An electrical energy converter refers to an apparatus that converts mechanical energy to electrical energy. Examples include an alternator, an alternator-rectifier and a generator.

A contactor refers to a single pole electromechanical commutator generally capable of operating under load current.

A reverser refers to a double pole, double throw electromechanical commutator operating only at no load current and commonly used with two crossing contacts to reverse the current direction in a part of a circuit.

A power control apparatus refers to an electrical apparatus that regulates, modulates or modifies AC or DC electrical power. Examples are an inverter, a chopper circuit, a boost circuit, a buck circuit or a buck/boost circuit.

A transistor is an electronic controlled device mainly used in the context of this patent as a power switching device capable of sequentially chopping a voltage waveform at a very fast rate. Typical examples of such a component are an IGBT, Insulated Gate Bipolar Transistor, or a MOSFET, Metal Oxide Semiconductor Field Effect Transistor.

Locomotive speed is the speed of the locomotive along the tracks and is typically expressed in miles per hour (MPH) or kilometers per hour.

Traction mode is the same as motoring mode where the vehicle is accelerating or maintaining speed.

Braking mode is where the vehicle is decelerating under application of at least one braking system.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

### BRIEF DESCRIPTION OF THE DRAWINGS

These and other objects and advantages of the invention will become apparent upon reading the detailed description and upon referring to the drawings in which:

FIG. 1 is a schematic view of the major components of a vehicle using the current invention.

FIG. 2 is a schematic illustration of basic circuit for normal DC traction control from a DC bus.

FIGS. 3a to 3c are schematic views circuit of a circuit according to an embodiment of the present invention showing circuit elements configured for normal motoring (a) and for dynamic braking (b,c).

FIG. 4 is a graph of braking effort versus locomotive speed of the circuit shown in FIGS. 3b and 3c.

FIG. 5 is a schematic view of a circuit according to another preferred embodiment of the present invention which is an improved circuit for series DC motor pairs.

FIGS. 6a and 6b are schematic views illustrating how the circuit of FIG. 5 operates in traction mode.

FIGS. 7a and 7b are schematic views illustrating how the circuits of FIG. 5 operate in braking mode, in high-speed and low-speed extended modes.

FIG. 8 is a graph of braking effort versus locomotive speed for standard and soft extended braking circuits for dynamic or regenerative braking.

FIG. 9 is a schematic view illustrating how the circuit of FIG. 5 may be used for self-loading the DC-bus in order to test the prime power sources, such as diesel-electric generators, battery packs, etc.

FIG. 10 is a schematic view illustrating the circuit of FIG. 5 with several pairs of motors.

FIG. 11 is a schematic view illustrating a variant of the circuit of FIG. 5 showing shared braking resistor elements.

FIG. 12 is a schematic view illustrating a variant of the circuit of FIG. 5 by which the soft extended dynamic braking circuit is transformed into the circuit as described in US patent application entitled “Dynamic Braking Circuit for a Hybrid Locomotive” filed Apr. 19, 2007 to Donnelly et al. This circuit enables fast traction motor reversal at almost constant torque.

### DETAILED DESCRIPTION OF PREFERRED EMBODIMENTS

The principal advantages of the electrical braking methods disclosed herein are:
the braking system substantially reduces the likelihood of wheel skid and the flat spots that can develop during skid
the braking system can be blended with the vehicle's mechanical friction brake in a way that is transparent to the operator
the dynamic braking systems disclosed herein use a minimum of power switching components
this method of dynamic braking allows the operator to apply brakes more aggressively since the likelihood of wheel skid is substantially reduced
the extended range dynamic braking circuits provide high levels of braking effort down to very low speeds, using traction choppers as boost converters
the braking system works effectively at low speeds. Conventional dynamic braking does not work effectively at low speeds for DC locomotives.

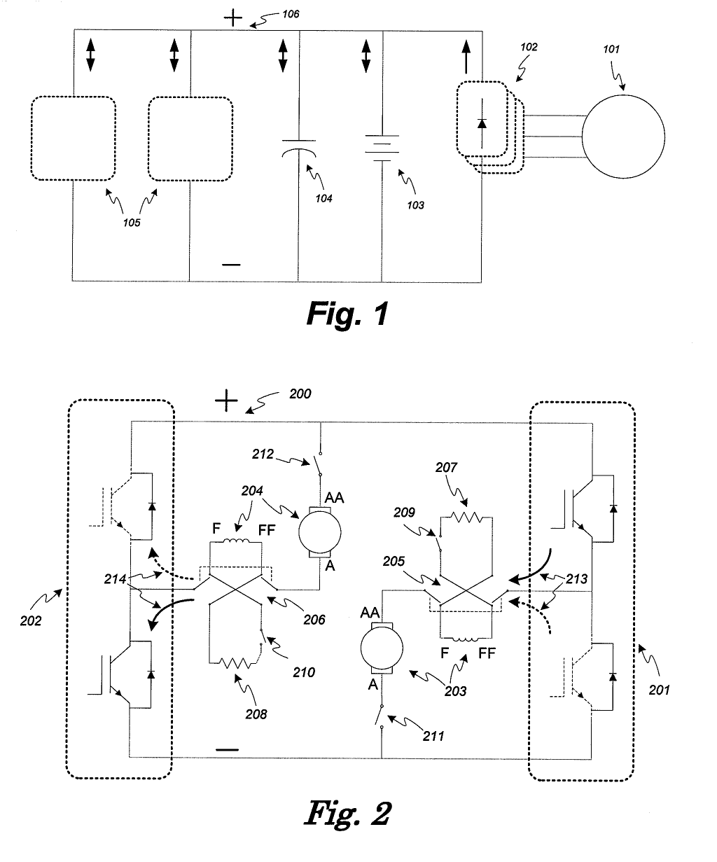

The DC bus system to which the present inventions refer is schematically, but not extensively, represented in FIG. 1. The DC bus 106 has positive and negative poles between which may be connected several sources of energy, consuming loads and energy storage devices as illustrated by arrows. Batteries 103, capacitor banks 104 and flywheel energy systems are such energy storage devices that also act as dampers by consuming or generating energy to oppose to any voltage variation. Batteries perform well at low power high energy while capacitors are more efficient for high power low energy transfers. Typical sources of energy may be DC supplies, gensets 101 and rectifiers 102, fuel cells and any other source of electrical DC voltage. Typical loads may be mostly resistive such as heaters or inductive such as motors. Motors and motor drives 105 usually consume power but may also produce electrical energy when motors are operated as generators such as in braking conditions. Generally, an energy efficient system is one that maximizes the recovery of braking energy into reusable consumable energy. For example, on a container lifting crane, there is theoretically as much energy recoverable in lowering a container as was necessary to previously lift the same container, given same initial and final height. Hence, an ideally efficient crane would, in average, require no prime energy source.

Even on a system that does not recover energy in any form of storage medium, using motors as generators and dissipating the braking energy in resistors will reduce the maintenance required on mechanical brakes, typically brake pads or shoes. The mechanical braking may be particularly aggressive in short distance movements requiring repeated accelerations and decelerations such as for urban busses, garbage trucks or yard switching locomotives. The use of electrical braking in transportation applications also emphasizes the fact that braking may be active for long periods such as, for example, a locomotive leading a train that goes on a descending slope for hundreds of kilometres.

Another characteristic of the scope of the inventions concerned herein is the use of pairs of series wounded DC motors as traction and braking motors. Those motors are used in many industrial applications such as container cranes or locomotives.

FIG. 2 illustrates the two most common chopper configurations used to drive DC motors from a DC bus with minimal parts count. The chopper 201 controls the propulsion of the motor 203. This motor, connected to the negative side of the DC bus through contactor 211 consists in a field winding (indicated by FF and F terminals) and an armature winding (indicated by AA and A terminals) as commonly identified in the locomotive industry. The reverser 205 is used to define the direction of rotation of the motor by inverting the current flow in the field winding. Current from the DC bus is increased in the motor windings by the upper-side transistor of the chopper 201. Once this rising current 213 (bold) is established, the transistor opens and the current 213 (dashed) then “freewheels” between field winding to armature winding, negative bus and the parasitic diode of the lower-side transistor of chopper 201. This later process consumes no energy from the DC bus. The lower-side transistor of chopper 201 is never required to operate and could be replaced by a diode. The left side of the FIG. 2 presents a similar operating scheme by which the second motor 204 is controlled by the chopper 202 but connected to the positive side of the DC bus through contactor 212. In this case, it is the lower side transistor of the chopper 202 that is used to control the current increase (214 bold) from the DC bus to the motor while it is the parasitic diode of the unused upper-side transistor that enables current (214 dashed) to “freewheel” through the positive bus without consuming energy. At some maximum speed, the armature voltage reaches the bus voltage and the motor cannot accelerate anymore. Engaging contactors 309 and 310 will deviate some of the field current into field shunting resistors 307 and 308, thus reducing the armature voltage and enabling speed increase. This process, well known in the rail industry as “field shunting” may be repeated with additional contactors and shunting resistors, not shown.

The circuit presented is for 2 motors. It may be reproduced for any number of similar pairs connected to the same DC bus. It is noted that exact similar behavior is obtained with both motors connected to either the positive or the negative side of the bus. The schematic illustrates the most common and essential switches required but others may be added for isolation, security or other reasons without affecting the basic operating principle.

### First Invention, Minimum Components Dynamic Braking

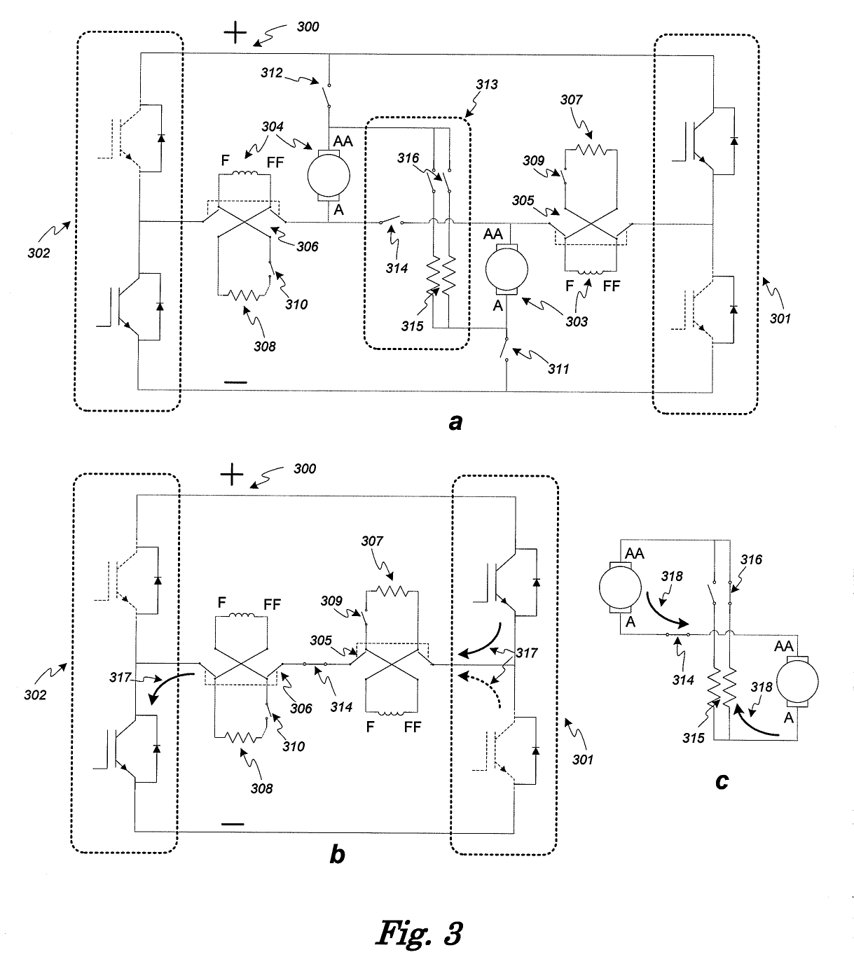

The first invention, illustrated in FIG. 3a, presents a circuit topology by which only few components are added to the previous circuit in order to implement electrical dynamic braking. Only braking resistors 315, configuring selectors 316 and a single power switch 314 per pair of motors are required. By inspection, it can be seen that with switches 314-316 open and 311-312 close, the circuit behaves as in FIG. 2 whereby chopper 301 is used, mainly through its upper-side transistor, to control the motor 303 propulsion current while chopper 302 is used, mainly through its lower-side transistor, to control the motor 304 current.

In order to activate the braking mode, the motor current is left uncontrolled until reduced to zero. Then, contactors 311-312 open, selector 316 connects some or the entire dynamic braking resistors 315 and contactor 314 close. The final circuit consists in 2 independent circuits, represented in FIGS. 3b and 3c, connected together in only one point, the contactor 314. With the lower-side transistor of the chopper 302 being permanently closed, the field current 317 of both motors in series is controlled by the upper-side transistor and the lower-side diode of chopper 301. With the motors previously in rotation, armature voltages are then developed in series, generating current 318 in the selected braking resistors 315. Since the contactor 314 is the only component carrying the current of both circuits, it is possible to prevent overcurrent by inverting the armature current direction with respect to the field current. If we assume that the motors of FIG. 3a rotate in the same direction as drawn, then, in braking mode, by changing reversers 305 and 306 as in FIG. 3b, the 2 armature voltages of FIG. 3c add together in series and create a current 318 in the opposite direction as the field current 317 also crossing the contactor 314.

The main advantage of this invention is the addition of stable dynamic braking functionality at minimal additional costs. However, with such a circuit, it is not possible to regenerate on the DC bus, the armature circuits not being connected to this DC bus. It can also be demonstrated that the same circuit can be developed with both motors initially connected through contactors 311 and 312 to the positive or negative side of the DC bus 300.

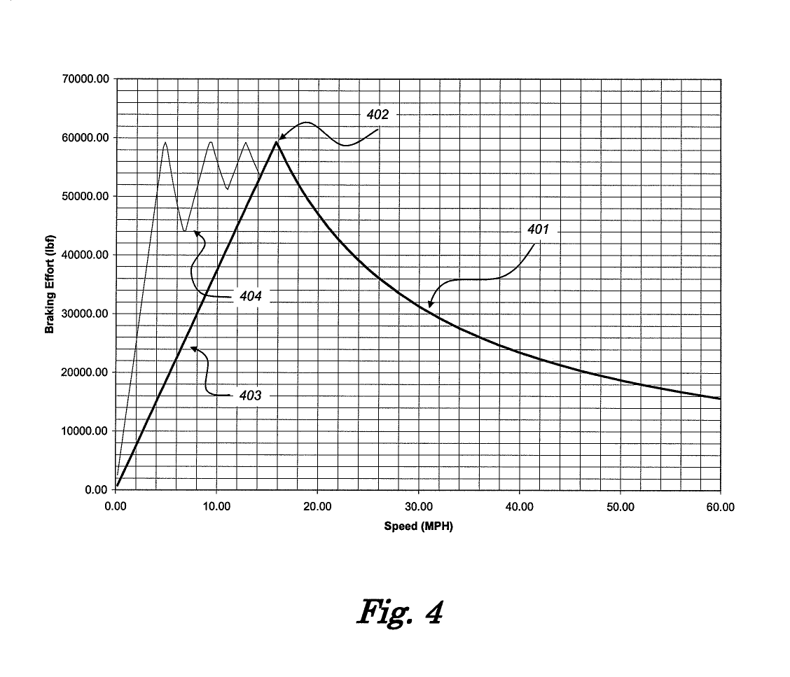

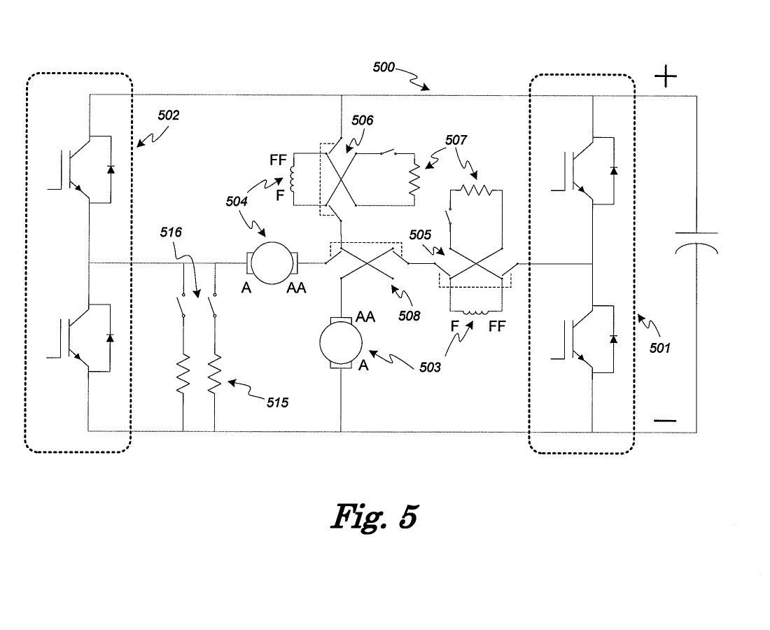

The FIG. 4 illustrates the basic braking performance of the circuit illustrated in FIG. 3b. At high speed, the braking effort 401 is limited by the maximum power rating of the braking resistor. In this speed range, to get a constant power in the braking resistor, hence a constant armature voltage, the field current has to increase while the speed reduces. At some point 402, the field current reaches the maximum circuit and/or motor capability. Below that maximum braking effort point, the field current is kept constant at its maximum set point. However, since the speed reduces with braking effort, the armature voltage decreases accordingly with the result of a constantly decaying torque and effort 403. Values shown are typical of a 6-axle locomotive using three pairs of motors. However, different results may be practically obtained, depending on the motor type, resistive grid power and chosen circuit limitations. As indicated with curve 404, an extended low speed braking curve may be obtained by changing the braking resistor values through a combination of expensive extra contactors to increase the braking effort in several steps.

According to the present invention, there is provided a method of braking a vehicle, the vehicle comprising the components as shown in FIG. 3a. The vehicle includes a pair of traction motor circuits 303, 304 for moving the vehicle and generating electrical energy when the vehicle is decelerating. Each traction motor circuit 303, 304 comprises a field winding and an armature winding, the field and armature windings being connected in series. Each armature winding has an input terminal and an output terminal. Each traction motor circuit has a switchable contact reverser 305, 306 operable to switch electrical current in opposite directions of flow through the armature and field windings of a selected one of the pair of traction motor circuits. A power source is used to provide electrical energy to each traction motor circuit. The vehicle also includes a direct current (DC) bus 300 interconnecting each traction motor circuit and the power source. The vehicle also comprises first and second pairs 301, 302 of first and second transistors, each of said first and second transistors comprising an input and an output. The first pair 301 of first and second transistors is connected in parallel with the second pair 302 of first and second transistors to the DC bus 300. In each of the first and second pairs of transistors, the output of the first transistor is connected to the input of the second transistor. The first of the pair of traction motor circuits 303 is connected, through a first contactor 311, in parallel with the first transistor of the first transistor pair 301. The second of the pair of traction motor circuits 304 is connected, through a second contactor 312, in parallel with the second transistor of the second transistor pair 302. The input terminal of the armature winding of the first of the pair of traction motor circuits is connected through a third contactor 314 to the output terminal of the armature winding of the second of the pair of traction motor circuits. The output terminal of the armature winding of the first of the pair of traction motor circuits is connected to the input terminal of the armature winding of the second of said pair of traction motor circuits through a first connection comprising a power switch 316 and a first braking resistor 315 connected in series. The first connection is connected between a second connection connecting the output terminal of the armature winding of the first of the pair of traction motor circuits 303 to the first contactor 311 and a third connection connecting the input terminal of the armature winding of the second of the pair of traction motor circuits 304 to the second contactor 312. In a motoring mode, the first and second contactors 311,312 are closed, and the power switch 316 and third contactor 314 are open. The method comprises the steps of:
a) releasing motor current until reduced to substantially zero;
b) opening the first and second contactors; and
c) closing the power switch and the third contactor.

Consequently, according to a preferred embodiment of the invention, two choppers and three power contactors are used to control electrical traction power from a DC bus to two series DC traction motors and dynamic braking from the same two series DC motors to a braking resistor grid.

### Second Embodiment

### Improved “Soft” Extended Braking Circuit

The circuit of FIG. 5 is a preferred embodiment configuration for a regenerative and/or dynamic braking circuit. As shown in the figure, only the required components of the circuit are illustrated which consist mainly in 2 choppers (501, 502), a braking resistor grid 515, braking resistor selectors 516 and three reversers (505, 506 & 508) per pair of motors. However, it is possible to add any number of extra contactors or switches for isolation, protection and security without affecting the basic operation of the invention. As presented in FIG. 5, the circuit is in normal motoring mode.

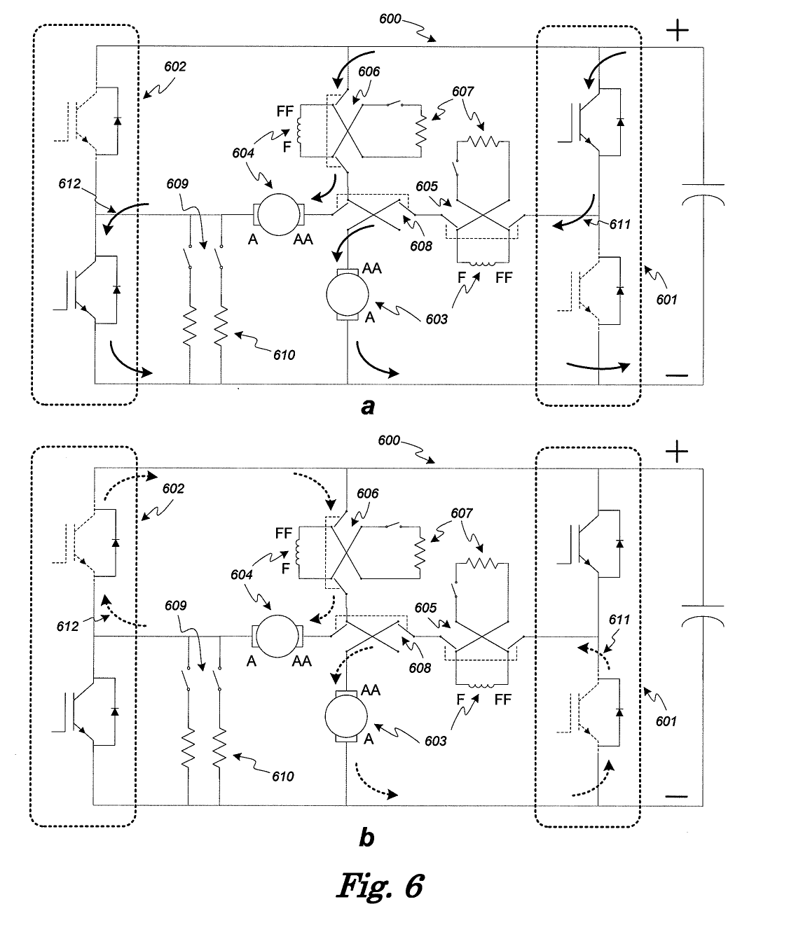

FIG. 6 illustrates specifically the circuit in motoring mode where the current 611 in motor 603 series connected field and armature windings is controlled, as in previous circuits of FIGS. 1 and 2, by the chopper 601. Similarly, current 612 in motor 604 is controlled by chopper 602. Reverser switch 608 is configured so as to isolate the two motor circuits. For a portion of the motoring duty cycle as shown in FIG. 6a, power is provided to the traction motors from a DC bus 600 as shown by the current 611 and 612 when the upper-side transistor of chopper 601 and lower-side transistor of chopper 602 are conducting. For the other portion of the motoring duty cycle as shown in FIG. 6b, current 611 and 612 freewheel as shown by the current arrows when both choppers are deactivated and do not consume power from the DC bus 600. The portion of bus-fed current versus freewheel can be set out-of-phase between each motor to minimize DC bus current ripple. Similarly, it can be set out-of-phase with other pairs of motors.

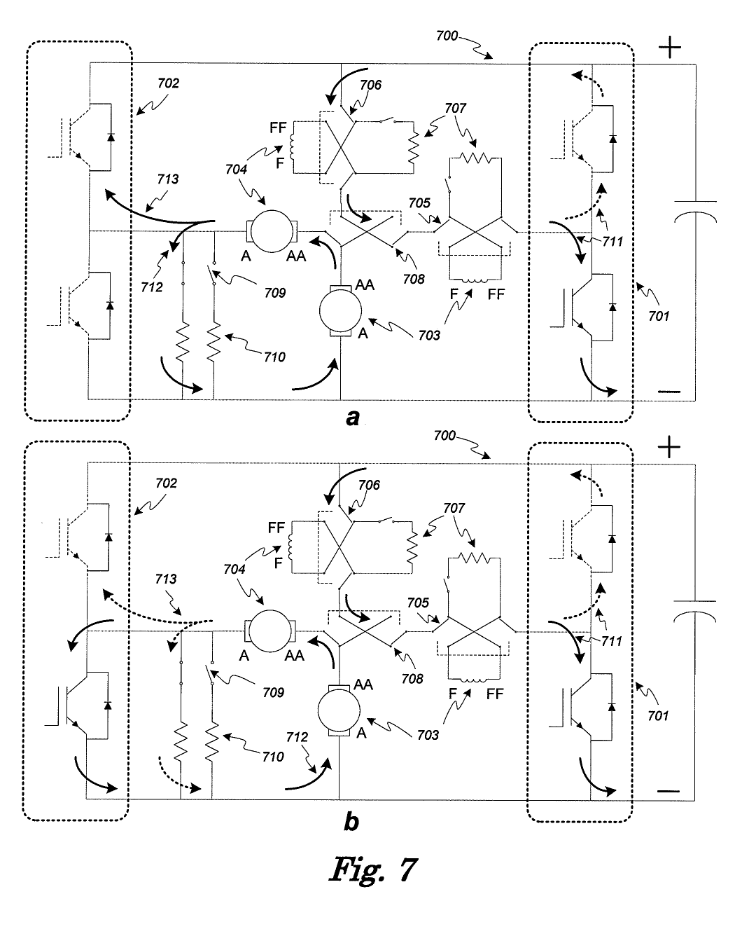

As shown in FIG. 7a for dynamic braking, the “mode” reverser 705 is now configured so as to provide a first circuit with field windings of motors 703 and 704 in series, and a second separate circuit with armature windings of the same motors in series. With motors previously rotating in the direction imposed by the configuration of circuit of FIG. 6, the direction reversers 605 and 606 have to be switched as indicated by reversers 705 and 706. With this new configuration, the chopper previously used for controlling the traction on motor 703 is now used for controlling the field current of both motors 703 and 704. As the field current increases, and since the motors were already rotating, the two series motor armature voltages also increase. When the sum of the two armature voltages is less than the DC bus 700 voltage, current 712 flows from the armatures to the braking resistors 710 selected by the switches 709. As reviewed previously for traction current control, field current 711 is now controlled by the lower-side transistor of chopper 701 and freewheels through the upper-side diode of the same chopper. When the sum of the armature voltages exceeds the DC bus voltage, a current 713 start to flow from the motor armatures to the DC bus. Doing so enables the current 713 to provide power to all auxiliary circuits connected to the DC bus as well as the field current of the motors. Hence, using the vehicle inertia, it is possible to control the braking effort while providing local power without even having one of the prime energy sources in operation, what we will call self-supply. In addition, if the DC bus voltage is connected to an energy storage device, the current 713 may also be used as a regenerative source of power.

Consequently, according to the present invention there is also provided a method of braking a vehicle, the vehicle comprising a pair of traction motor circuits for moving the vehicle and generating electrical energy when the vehicle is decelerating. As shown in FIG. 5, each traction motor circuit 503, 504 comprises a field winding and an armature winding, the field and armature windings being connected in series. Each armature winding has an input terminal and an output terminal. Each traction motor circuit 503, 504 comprises a switchable contact reverser 505, 506 operable to switch electrical current in opposite directions of flow through the armature and field windings of a selected one of the pair of traction motor circuits. A third switchable contact reverser 508 is provided to selectively connect in series each field winding to its corresponding armature winding within each said traction motor circuit or connect in series the field winding of the first traction motor circuit to the field winding of the second traction motor circuit and the armature winding of the first traction motor circuit to the armature winding of the second traction motor circuit. The vehicle also comprises a power source to provide electrical energy to each traction motor circuit 503, 504. A direct current (DC) bus 500 interconnects each traction motor circuit and the power source. The vehicle also includes first and second pairs 501, 502 of first and second transistors, each of the first and second transistors comprising an input and an output. The first pair 501 of first and second transistors is connected in parallel with the second pair 502 of first and second transistors to the DC bus 500. In each of the first and second pairs of transistors 501, 502, the output of the first transistor is connected to the input of the second transistor. A first of the pair of traction motor circuits 503 is connected in parallel with the first transistor of the first transistor pair 501. A second of the pair of traction motor circuits 504 is connected in parallel with the second transistor of the second transistor pair 502. A braking resistor grid is connected in parallel with the first transistor of the second transistor pair 502, the braking resistor grid comprising a switch 516 and a resistor 515 connected in series. In a motoring mode, the third switchable contact reverser 508 is configured to connect in series each field winding to its corresponding armature winding within each said traction motor circuit and the braking resistor grid switch 516 is open. The method of braking comprises the steps of:
a) releasing motor current until reduced to substantially zero;
b) switching the third switchable contact reverser 508 to connect in series the field winding of the first traction motor circuit to the field winding of the second traction motor circuit and the armature winding of the first traction motor circuit to the armature winding of the second traction motor circuit; and
c) closing the braking resistor grid switch 516.

With two pairs of motors, one circuit such as illustrated in FIG. 7a may first be used to provide power to the DC bus without any braking resistors connected while the second circuit is controlled to provide the required braking effort to the resistive grid. When the second circuit voltage reaches the DC bus voltage, the first circuit is then controlled for the required braking effort increase until it also reaches the bus voltage corresponding to the maximum vehicle braking effort.

As for the circuit of the first invention of FIG. 3b, when the speed reduces because of braking, the field current has to increase to maintain a given level of braking effort. Below the maximum point 402 of FIG. 4, field current can not be increased anymore thus making the armature voltage to gradually collapse to zero with decreasing speed. A very attractive aspect of this second invention is illustrated in FIG. 7b where the second chopper circuit 702 is now put in contribution as a “boost” circuit to maintain the motor armature current 712 constant and, doing so, keep the braking effort constant with decreasing speed. When the lower-side transistor of chopper 702 conducts, current 712 in the armature windings increases. When the transistor opens, the accumulated energy in the motor armature inductances is fed via current 713 to the braking resistors and the DC bus 700. As the speed reduces, the portion of time the transistor conducts increase up to a point where there is not enough energy remaining in the armature except for burning braking effort in the motor armature resistances themselves with the lower-side transistor of chopper 702 permanently closed. For a standard locomotive with DC motors, this point of operation lies in the 1 MPH range, when it is almost completely stopped. From that point down to zero speed the motor gradually lose its braking capacity. Since there is still no braking effort possible at zero motor speed, the increase in low-speed braking capacity does not involve any added risks of wheel locking due to braking effort.

According to the present invention, there is provided a circuit by which two choppers and a combination of power switches, typically three reversers, are used to control:
Electrical traction power from a DC bus to two series DC traction motors,
Dynamic braking from the same two series DC motors to a braking resistor grid,
Regenerative braking from same two series DC traction motors to a DC bus,
Constant effort (“soft”) extended braking down to low-speed and
Self-loading of the input DC power supply through braking resistor grid (as will be explained in the next section in more detail).

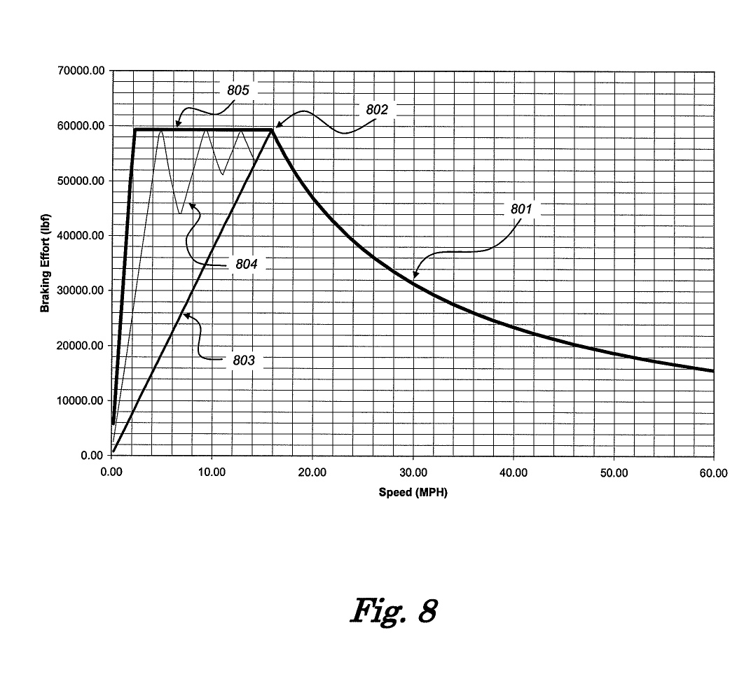

FIG. 8 compares the different braking characteristics of the previous invention (similar to standard DC motor locomotive braking characteristics) with the extended braking option 804 of a standard locomotive or invention 1 and the new proposed “soft” extended braking effort 805 of this last invention; characterized by the “flat” behavior of the low-speed braking capacity down to very low speed.

### Self-Load Function

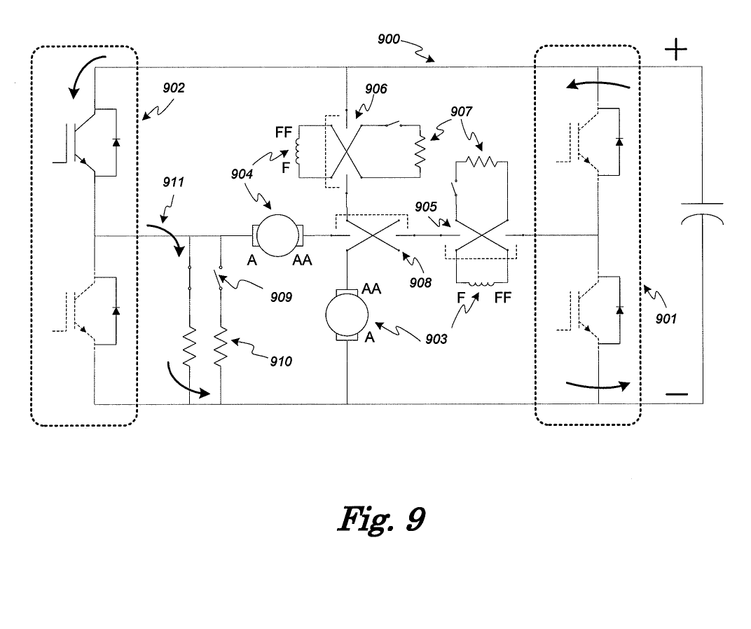

Another very interesting aspect of this second invention circuit of FIG. 5 is shown in FIG. 9. With a vehicle equipped with a resistive braking device such as the braking grid, it very convenient to be able to use this resistor to test the prime energy sources. Such testing, called “self-load”, may be used at the construction of the vehicle, after maintenance, to test for required maintenance or for periodic inspection of the prime energy source characteristics.

In the vehicle using this invention, the prime energy source provides power to the DC bus 900. All reversers 905, 906 and 908 in their “open” state insure that no current could ever flow in the traction motors during the test. Depending on the power level applied for the test, more or less of the resistor grid elements 910 are selected through switches 909. Then, by switching the upper-side transistor of chopper 902 and controlling its duty cycle, it is possible to load the prime power source in a continuously variable level up to the application of the full braking resistor grid. This last operating mode of the second invention uses the upper-side transistor of the chopper 902 for the first time.

### Basic Variants

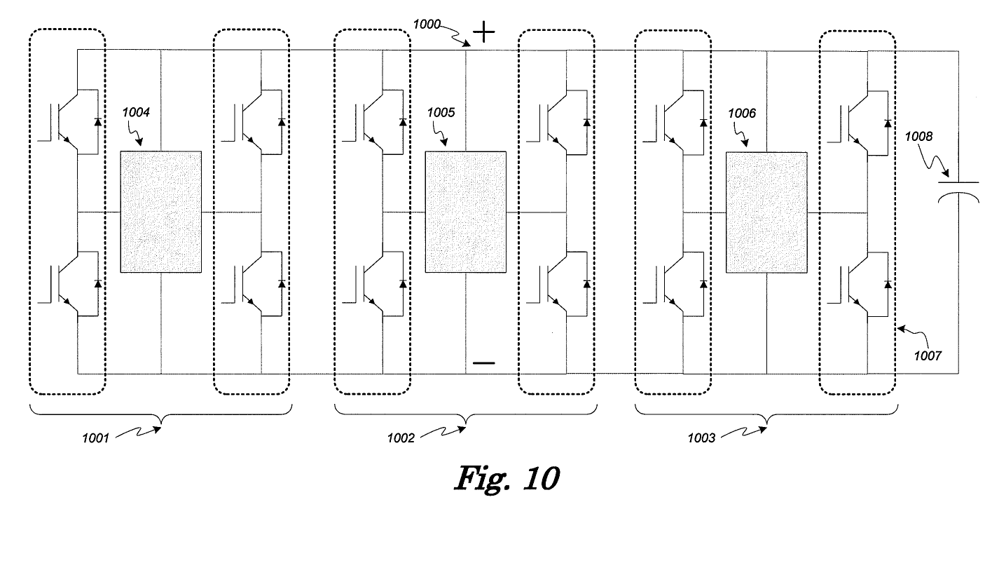

FIG. 10 illustrates the use of the circuits of either the first or the second invention for equipment with multiple DC traction motors. Reflecting the basic representation of FIG. 1, the DC bus 1000 is connected in this example to three pairs of traction motors and drives 1001, 1002 and 1003. The circuits 1004,1005 and 1006 may be either the configurations of FIG. 3a (first invention) or 5 (second invention).

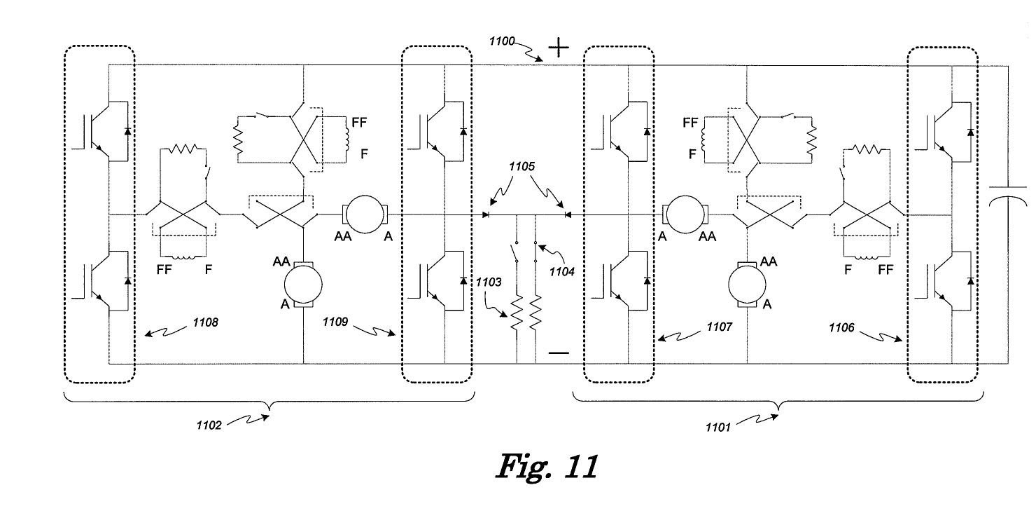

FIG. 11 shows a variant of the second invention where the brake resistive power is shared by two drive circuits 1101 and 1102 for two pairs (4 totals) of motors. More pairs can also be added with the same performance. The amount of braking power is controlled by a combination of elements as explained in more details with FIG. 7. Those elements include selectors 1104, the motor's field current controlled by the lower side transistor of choppers 1106 and 1108 and the motor's armature current, controlled by the lower-side transistors of choppers 1107 and 1109 in low speed mode. The main difference with circuit of FIG. 7 however is that the braking resistors 1103 are simultaneously supplied by both drive circuits through diodes 1105.

### High-Speed Direction Reversal

The circuit of the second invention shown in FIG. 5 enables traction, dynamic braking and regenerative braking with a minimum of components. However, to achieve all those mode of operation, it is necessary to change the power switches positions. Because of the relatively long operating times of some power switches and the desire to minimize current switching for durability of contacts, changing modes require safety delays that are cumbersome. The circuit of FIG. 5 has the benefit of maintaining braking torque down to very low speed but not to 0, a characteristic appropriate to prevent wheel skid. It then requires mechanical switch operation to go from brake to traction modes. In some operating conditions requiring frequent direction reversal with and without load, as can be found in rail yard locomotive operations, it would be desired to reverse direction rapidly while controlling the torque.

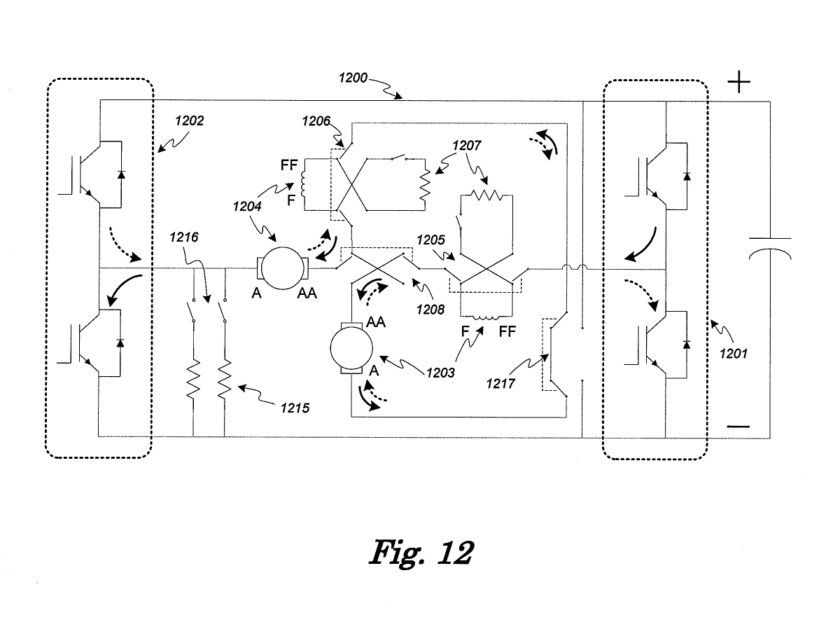

FIG. 12 shows a variant of the second invention with the addition of a modified fourth reverser 1217 which has one side connection bar instead of the previous common cross bars of the other reversers. With this extra reverser in the position opposite to the one shown in FIG. 12, we get the exact circuit of second invention shown in FIG. 5 with all its behavior, characteristics and benefits. However, when switched in the position shown in FIG. 12, the two windings of the pair of motors 1203 and 1204 are now all connected in series. The choppers 1201 and 1202 may now be used in a classical four quadrant drive topology by which it is possible to engage traction and regenerative, or dynamic, braking with minimum changes to the position of the electromechanical switches. The main benefit resides in the capability to reverse direction and maintain torque through zero-speed without mechanical switch operation.

According to this other embodiment, with the addition of a set of power switches, typically a modified reverser, it is possible to enable either the behavior of the circuit shown in FIG. 5 with two series DC traction motors and a DC bus or low-speed operation of the traction and dynamic braking functions in both forward and reverse directions using four quadrant electronic control and minimal mechanical power switches operation. Braking may be dynamic in resistors or regenerative to the DC bus.

The FIG. 12 shows the two current polarities with bold and dashed arrows. A typical forward-reverse-forward cycle is explained as follows. First, from stop position, the forward traction current (first quadrant, positive armature voltage and positive current) is controlled by the combination of chopper 1201 upper-side transistor and chopper 1202 lower-side transistor. To enable braking, direction reversers 1205 and 1206 are switched in opposite polarity and the current is controlled as indicated by the dashed arrows with chopper 1202 upper-side transistor and chopper 1201 lower-side transistor (second quadrant, positive armature voltage and negative current). With this mode of operation kept active, the armature voltages progressively collapse to 0 at zero speed and then start to increase again in reverse polarity (third quadrant, negative armature voltage and negative current) representing the reverse traction mode. To brake again, the reversers 1205 and 1206 are brought back in the position shown and the same transistors used for initial forward traction are activated to create a current flowing as per the bold line until armature voltages collapse again (fourth quadrant, negative armature voltage and positive current) until 0 speed, stop. The main advantage of this circuit is the capability of maintaining constant torque (armature and field current) through speed reduction and subsequent increase in reverse direction thus enabling rapid direction reversal with or without load.

With both armature and field windings in series, it becomes imperative to insure stability of the system and prevent against destructive positive feedback in braking modes (second and fourth quadrants above) when armature voltage polarity is opposed to current. Hence, for security, the braking modes with the reverser 1217 in this position should be limited in speed to insure that the sum of the two armature voltages is less than the DC bus 1200 voltage. For a typical DC motors locomotive, this circuit should be limited to below 10 to 12 MPH, convenient for most yard operation requirements.

The present invention, in various embodiments, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, for example for improving performance, achieving ease and\or reducing cost of implementation. The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention. Moreover though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A method of braking a vehicle, the vehicle comprising a pair of traction motor circuits for moving the vehicle and generating electrical energy when the vehicle is decelerating, wherein each said traction motor circuit comprises a field winding and an armature winding, the field and armature windings being connected in series, each armature winding having an input terminal and an output terminal, wherein each said traction motor circuit comprises a switchable contact reverser operable to switch electrical current in opposite directions of flow through the armature and field windings of a selected one of the pair of traction motor circuits, a power source to provide electrical energy to each said traction motor circuit, a direct current (DC) bus interconnecting each said traction motor circuit and said power source, and first and second pairs of first and second switching transistors, each of said first and second transistors comprising an input and an output, wherein the first pair of first and second transistors is connected in parallel with the second pair of first and second transistors to the DC bus, wherein in each of said first and second pairs of transistors, the output of the first transistor is connected to the input of the second transistor, wherein a first of said pair of traction motor circuits is connected, through a first contactor, in parallel with the first transistor of the first transistor pair, a second of said pair of traction motor circuits is connected, through a second contactor, in parallel with the second transistor of the second transistor pair, wherein the input terminal of the armature winding of the first of said pair of traction motor circuits is connected through a third contactor to the output terminal of the armature winding of the second of said pair of traction motor circuits, wherein the output terminal of the armature winding of the first of said pair of traction motor circuits is connected to the input terminal of the armature winding of the second of said pair of traction motor circuits through a first connection comprising a power switch and a first braking resistor connected in series, wherein said first connection is connected between a second connection connecting the output terminal of the armature winding of the first of said pair of traction motor circuits to the first contactor and a third connection connecting the input terminal of the armature winding of the second of said pair of traction motor circuits to the second contactor, and wherein, in a motoring mode, said first and second contactors are closed, and said power switch and third contactor are open, the method comprising the steps of:
a) releasing motor current until reduced to substantially zero;
b) opening the first and second contactors; and
c) closing the power switch and the third contactor.

2. A traction motor control circuit adapted for motoring and braking a vehicle, the vehicle comprising:
a pair of traction motor circuits for moving the vehicle and generating electrical energy when the vehicle is decelerating, wherein each said traction motor circuit comprises a field winding and an armature winding, the field and armature windings being connected in series, each armature winding having an input terminal and an output terminal, wherein each said traction motor circuit comprises a switchable contact reverser operable to switch electrical current in opposite directions of flow through the armature and field windings of a selected one of the pair of traction motor circuits, a power source to provide electrical energy to each said traction motor circuit, a direct current (DC) bus interconnecting each said traction motor circuit and said power source, and first and second pairs of first and second transistors, each of said first and second transistors comprising an input and an output, wherein the first pair of first and second transistors is connected in parallel with the second pair of first and second transistors to the DC bus, wherein in each of said first and second pairs of transistors, the output of the first transistor is connected to the input of the second transistor, wherein a first of said pair of traction motor circuits is connected, through a first contactor, in parallel with the first transistor of the first transistor pair, a second of said pair of traction motor circuits is connected, through a second contactor, in parallel with the second transistor of the second transistor pair, wherein the input terminal of the armature winding of the first of said pair of traction motor circuits is connected through a third contactor to the output terminal of the armature winding of the second of said pair of traction motor circuits, wherein the output terminal of the armature winding of the first of said pair of traction motor circuits is connected to the input terminal of the armature winding of the second of said pair of traction motor circuits through a first connection comprising a power switch and a first braking resistor connected in series, and wherein said first connection is connected between a second connection connecting the output terminal of the armature winding of the first of said pair of traction motor circuits to the first contactor and a third connection connecting the input terminal of the armature winding of the second of said pair of traction motor circuits to the second contactor.

3. A method of braking a vehicle, the vehicle comprising a pair of traction motor circuits for moving the vehicle and generating electrical energy when the vehicle is decelerating, wherein each said traction motor circuit comprises a field winding and an armature winding, the field and armature windings being connected in series, each armature winding having an input terminal and an output terminal, wherein each said traction motor circuit comprises a switchable contact reverser operable to switch electrical current in opposite directions of flow through the armature and field windings of a selected one of the pair of traction motor circuits, and wherein a third switchable contact reverser is provided to selectively connect in series each field winding to its corresponding armature winding within each said traction motor circuit or connect in series the field winding of the first traction motor circuit to the field winding of the second traction motor circuit and the armature winding of the first traction motor circuit to the armature winding of the second traction motor circuit, a power source to provide electrical energy to each said traction motor circuit, a direct current (DC) bus interconnecting each said traction motor circuit and said power source, and first and second pairs of first and second transistors, each of said first and second transistors comprising an input and an output, wherein the first pair of first and second transistors is connected in parallel with the second pair of first and second transistors to the DC bus, wherein in each of said first and second pairs of transistors, the output of the first transistor is connected to the input of the second transistor, wherein a first of said pair of traction motor circuits is connected in parallel with the first transistor of the first transistor pair, a second of said pair of traction motor circuits is connected in parallel with the second transistor of the second transistor pair, wherein a braking resistor grid is connected in parallel with the first transistor of the second transistor pair, said braking resistor grid comprising a switch and a resistor connected in series, and wherein, in a motoring mode, the third switchable contact reverser is configured to connect in series each field winding to its corresponding armature winding within each said traction motor circuit and said braking resistor grid switch is open, the method comprising the steps of:
a) releasing motor current until reduced to substantially zero;
b) switching the third switchable contact reverser to connect in series the field winding of the first traction motor circuit to the field winding of the second traction motor circuit and the armature winding of the first traction motor circuit to the armature winding of the second traction motor circuit; and
c) closing the braking resistor grid switch.

4. A traction motor control circuit adapted for motoring and braking a vehicle, the vehicle comprising:
a pair of traction motor circuits for moving the vehicle and generating electrical energy when the vehicle is decelerating, wherein each said traction motor circuit comprises a field winding and an armature winding, the field and armature windings being connected in series, each armature winding having an input terminal and an output terminal, wherein each said traction motor circuit comprises a switchable contact reverser operable to switch electrical current in opposite directions of flow through the armature and field windings of a selected one of the pair of traction motor circuits, and wherein a third switchable contact reverser is provided to selectively connect in series each field winding to its corresponding armature winding within each said traction motor circuit or connect in series the field winding of the first traction motor circuit to the field winding of the second traction motor circuit and the armature winding of the first traction motor circuit to the armature winding of the second traction motor circuit, a power source to provide electrical energy to each said traction motor circuit, a direct current (DC) bus interconnecting each said traction motor circuit and said power source, and first and second pairs of first and second transistors, each of said first and second transistors comprising an input and an output, wherein the first pair of first and second transistors is connected in parallel with the second pair of first and second transistors to the DC bus, wherein in each of said first and second pairs of transistors, the output of the first transistor is connected to the input of the second transistor, wherein a first of said pair of traction motor circuits is connected in parallel with the first transistor of the first transistor pair, a second of said pair of traction motor circuits is connected in parallel with the second transistor of the second transistor pair, and wherein a braking resistor grid is connected in parallel with the first transistor of the second transistor pair, said braking resistor grid comprising a switch and a resistor connected in series.

5. The method of claim 3, wherein the vehicle further comprises a modified switchable contact reverser provided to selectively connect in series the first traction motor circuit to the second traction motor circuit while disconnecting the first traction motor circuit from the first transistor of the first transistor pair, or disconnect the first traction motor circuit from the second traction motor circuit while connecting the first traction motor circuit in parallel with the first transistor of the first transistor pair.

6. The method of claim 5, wherein when the vehicle is in a dynamic braking mode, a sum of voltages of the armature windings is less than a DC bus voltage.

7. The traction motor control circuit of claim 4, wherein the vehicle further comprises a modified switchable contact reverser provided to selectively connect in series the first traction motor circuit to the second traction motor circuit while disconnecting the first traction motor circuit from the first transistor of the first transistor pair, or disconnect the first traction motor circuit from the second traction motor circuit while connecting the first traction motor circuit in parallel with the first transistor of the first transistor pair.

8. The traction motor control circuit of claim 7, wherein when the vehicle is in a dynamic braking mode, a sum of voltages of the armature windings is less than a DC bus voltage.

9. The method of claim 3, wherein the vehicle further comprises a second pair of traction motor circuits for moving the vehicle and generating electrical energy when the vehicle is decelerating, wherein each said traction motor circuit of the second pair comprises a field winding and an armature winding, the field and armature windings being connected in series, each armature winding having an input terminal and an output terminal, wherein each said traction motor circuit of the second pair comprises a switchable contact reverser operable to switch electrical current in opposite directions of flow through the armature and field windings of a selected one of the second pair of traction motor circuits, and wherein a third switchable contact reverser is provided to selectively connect in series each field winding to its corresponding armature winding within each said traction motor circuit of the second pair or connect in series the field winding of the first traction motor circuit of the second pair to the field winding of the second traction motor circuit of the second pair and the armature winding of the first traction motor circuit of the second pair to the armature winding of the second traction motor circuit of the second pair, and third and fourth pairs of first and second transistors, each of said first and second transistors comprising an input and an output, wherein the third pair of first and second transistors is connected in parallel with the fourth pair of first and second transistors to the DC bus, wherein in each of said third and fourth pairs of transistors, the output of the first transistor is connected to the input of the second transistor, wherein a first of said second pair of traction motor circuits is connected in parallel with the first transistor of the third transistor pair, a second of said second pair of traction motor circuits is connected in parallel with the second transistor of the fourth transistor pair, wherein the braking resistor grid is also connected in parallel with the first transistor of the fourth transistor pair through a first series diode and wherein the braking resistor grid is connected in parallel with the first transistor of the first transistor pair through a second series diode.

10. The traction motor control circuit of claim 4, wherein the vehicle further comprises a second pair of traction motor circuits for moving the vehicle and generating electrical energy when the vehicle is decelerating, wherein each said traction motor circuit of the second pair comprises a field winding and an armature winding, the field and armature windings being connected in series, each armature winding having an input terminal and an output terminal, wherein each said traction motor circuit of the second pair comprises a switchable contact reverser operable to switch electrical current in opposite directions of flow through the armature and field windings of a selected one of the second pair of traction motor circuits while maintaining a same flow direction in the other armature and field windings of the other traction motor circuit of the second pair, and wherein a third switchable contact reverser is provided to selectively connect in series each field winding to its corresponding armature winding within each said traction motor circuit of the second pair or connect in series the field winding of the first traction motor circuit of the second pair to the field winding of the second traction motor circuit of the second pair and the armature winding of the first traction motor circuit of the second pair to the armature winding of the second traction motor circuit of the second pair, and third and fourth pairs of first and second transistors, each of said first and second transistors comprising an input and an output, wherein the third pair of first and second transistors is connected in parallel with the fourth pair of first and second transistors to the DC bus, wherein in each of said third and fourth pairs of transistors, the output of the first transistor is connected to the input of the second transistor, wherein a first of said second pair of traction motor circuits is connected in parallel with the first transistor of the third transistor pair, a second of said second pair of traction motor circuits is connected in parallel with the second transistor of the fourth transistor pair, wherein the braking resistor grid is also connected in parallel with the first transistor of the fourth transistor pair through a first series diode and wherein the braking resistor grid is connected in parallel with the first transistor of the first transistor pair through a second series diode.

11. The method of claim 3, wherein each switchable contact reverser is operable in an open state preventing current from passing therethrough and the method further comprising the steps of:
d) transitioning each switchable contact reverser to its open state;
e) switching the second transistor of the second pair of transistors and controlling a duty cycle of the second transistor of the second pair of transistors; and
f) loading the power source in a continuously variable level up to an application of the braking resistor grid.

12. The traction motor control circuit of claim 4, wherein each switchable contact reverser is operable in an open state preventing current from passing therethrough.
